(19) United States
(12) Patent Application Publication
(10) Pub. No.: US 2012/0029108 A1
(43) Pub. Date: Feb. 2, 2012

(54) UV-CURABLE INK JET INK COMPOSITION

(75) Inventors: Hiroki NAKANE, Matcumoto-shi (JP); Jun Ito, Nagano-ken (JP)

(73) Assignee: SEIKO EPSON CORPORATION.

(21) Appl. No.: 13/180,639

(22) Filed: Jul. 12, 2011

(30) Foreign Application Priority Data
Jul. 29, 2010 (JP) 2010-170433

(51) Int. Cl. C09D 11/10; C08F 2/50; C09D 4/02

(52) U.S. Cl. 522/26; 522/28

(57) ABSTRACT

A UV-curable ink jet ink composition contains a polymerizable compound, a photopolymerization initiator containing an acylphosphine-based photopolymerization initiator having a phenyl group in the molecule thereof, and a fluorescent brightening agent. The fluorescent brightening agent in a predetermined concentration has a higher maximum absorbance than the photopolymerization initiator in the same concentration, in a wavelength region of 360 to 420 nm.

### BACKGROUND

1. Technical Field

The present invention relates to a UV-curable ink jet ink composition.

2. Related Art

The ink jet recording method is one of the recording methods and in which printing is performed by ejecting droplets of an ink composition onto a recording medium, such as a paper sheet. The ink jet recording method features high-speed printing of high-resolution, high-quality images, and is therefore being increasingly used in various technical fields. The ink jet recording method often uses UV-curable ink compositions. Such a UV-curable ink composition may contain a sensitizer to accelerate the initiation reaction of a photopolymerization initiator.

One of the most popular sensitizers is a thioxanthone-based sensitizer. However, if a thioxanthone-based sensitizer is used in an ink composition, the ink composition is likely to be stained when is cured, or the initial hue of the cured film is likely to be poor.

For example, JP-A-2006-274025 discloses an ink composition containing a polymerizable compound, a photopolymerization initiator having an absorption wavelength region, a polymerization promoter, and a fluorescent brightening agent having an absorption wavelength region overlapping with that of the photopolymerization initiator. This ink composition is characterized in that it has high curability and good hue.

When the absorption wavelength regions of the fluorescent brightening agent and the photopolymerization initiator overlap, the sensitivity is reduced. In order to prevent the degradation of the sensitivity, an ink composition disclosed in JP-A2006-274025 contains a photopolymerization initiator that absorbs light having long wavelengths so that the absorption wavelength region of the photopolymerization initiator overlaps with the emission wavelength of the fluorescent brightening agent. However, a white ink of this type cannot sufficiently prevent the degradation of the sensitivity if it contains a high concentration of titanium oxide.

Accordingly, JP-A-2009-191118 discloses a white ink composition that can be sensitively cured by being irradiated with active radiation (light). This ink composition contains a white pigment, a polymerizable compound, a polymerization initiator, and a fluorescent brightening agent and absorbs light having wavelengths in a range in which the absorption spectrum of the polymerization initiator and the emission spectrum of the fluorescent brightening agent overlap with each other.

However, this ink composition is inferior in curability and hue. More specifically, in this ink composition, the polymerization speed of the polymerizable compound is extremely low, and the b* value in the CIE Lab color space is excessively high. The ink composition can be further improved in these points.

### SUMMARY

Accordingly, an advantage of some aspects of the invention is that it provides a UV-curable ink jet ink composition having a high curability, that is, containing a polymerizable compound that can be polymerized at a high speed, and having a superior hue, that is, having a very low b* value.

The present inventors have conducted intensive research to solve the above issue. As a result, the inventors have found that in an ink composition, when the maximum absorbances in a specific wavelength region of the photopolymerization initiator and the fluorescent brightening agent have a specific relationship, the ink composition exhibits very high curability. Also, the amounts of the photopolymerization initiator and a known sensitizer (thioxanthones or the like) can be reduced or may not be used, by use of a fluorescent brightening agent as a sensitizer. Consequently, a stain of the cured film of the ink composition caused by at least either the photopolymerization initiator or the sensitizer can be reduced, and the hue of the cured film of the ink composition can be improved (the b* value can be reduced) in comparison with the case of using a sensitizer other than fluorescent brightening agents. The present inventors thus accomplished the invention. According to an aspect of the invention, a UV-curable ink jet ink composition is provided.

The UV-curable ink jet ink composition contains a polymerizable compound, a photopolymerization initiator containing an acylphosphine-based photopolymerization initiator having a phenyl group in the molecule thereof, and a fluorescent brightening agent. The fluorescent brightening agent in a predetermined concentration has a higher maximum absorbance than the photopolymerization initiator in the same concentration, in a wavelength region of 360 to 420 nm.

Preferably, the photopolymerization initiator contains bis(2,4,6-trimethylbenzoyl)phenylphosphine oxide.

The photopolymerization initiator content in the UV-curable ink jet ink composition may be 3.0% by mass or more.

Preferably, the fluorescent brightening agent is a thiophene benzoxazoyl derivative.

The fluorescent brightening agent content in the UV-curable ink jet ink composition may be in the range of 0.1% to 0.75% by mass.

### BRIEF DESCRIPTION OF THE DRAWINGS

The invention will be described with reference to the accompanying drawings, wherein like numbers reference like elements.

FIG. 1 is a plot showing the absorption spectra of photopolymerization initiators and sensitizers including a fluorescent brightening agent used in Examples I, II and III.

FIG. 2 is an enlarged fragment of FIG. 1.

### DESCRIPTION OF EXEMPLARY EMBODIMENTS

An embodiment of the invention will now be described in detail. The invention is not limited to the following embodiment, and various modifications may be made within the scope and spirit of the invention.

In the description hereinafter, “(meth)acrylate” refers to an acrylate and a corresponding methacrylate, and a (meth)acrylic compound refers to an acrylic and methacrylic compound.

### UV-Curable Ink Jet Ink Composition

In the present embodiment, the UV-curable ink jet ink composition (may be simply referred to as ink composition) is irradiated with light from a light source having a peak wavelength in the range of 350 to 450 nm.

The ink composition of the present embodiment contains a polymerizable compound, a photopolymerization initiator, and a fluorescent brightening agent. The photopolymerization initiator contains an acylphosphine-based photopolymerization initiator having a phenyl group in its molecule, and the fluorescent brightening agent in a predetermined concentration has a higher maximum absorbance than the photopolymerization initiator in the same concentration, in the wavelength region of 360 to 420 nm. The constituents of the ink composition will now be described in detail.

### Polymerizable Compound

The polymerizable compound used in the ink composition of the present embodiment is polymerized to be solidified by the function of the photopolymerization initiator when being irradiated with light, and it is not otherwise limited. For example, various monomers and oligomers having a monofunctional group, a bifunctional group, or a trifunctional or more polyfunctional group can be used.

Such monomers include (meth)acrylic acid, itaconic acid, crotonic acid, isocrotonic acid, maleic acid and other unsaturated carboxylic acids, their salts and esters, urethanes, amides and their anhydrides, acrylonitrile, styrene, unsaturated polyesters, unsaturated polyethers, unsaturated polyamides, and unsaturated urethanes. Such oligomers include oligomers produced from the above monomers such as linear acrylic oligomers, epoxy(meth)acrylates, aliphatic urethane (meth)acrylates, aromatic urethane (meth)acrylates, and polyester (meth)acrylates.

The polymerizable compound may contain an N-vinyl compound as another monofunctional or polyfunctional monomer. Examples of the N-vinyl compound include N-vinylformamide, N-vinylcarbazole, N-vinylacetamide, N-vinylpyrrolidone, N-vinylcaprolactam, acryloyl morpholine, and derivatives of these N-vinyl compounds.

Among those, (meth)acrylic acid esters or (meth)acrylates are preferred.

Such a (meth)acrylate may be a monofunctional (meth)acrylate, such as isoamyl(meth)acrylate, stearyl (meth)acrylate, lauryl(meth)acrylate, octyl(meth)acrylate, decyl(meth)acrylate, isomyristyl(meth)acrylate, isostearyl (meth)acrylate, 2-ethylhexyl-diglycol (meth)acrylate, 2-hydroxybutyl(meth)acrylate, 4-hydroxybutyl(meth)acrylate, butoxyethyl(meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl(meth)acrylate, tetrahydrofurfuryl(meth)acrylate, 2-(2-vinyloxyethoxy)ethyl (meth)acrylate, isobornyl(meth)acrylate, 2-hydroxyethyl (meth)acrylate, 2-hydroxypropyl(meth)acrylate, 2-hydroxy-3-phenoxypropyl(meth)acrylate, flexible lactone-modified (meth)acrylate, t-butylcyclohexyl(meth)acrylate, dicyclopentenyl(meth)acrylate, dicyclopentenyloxyethyl (meth)acrylate, or isobornyl(meth)acrylate.

Bifunctional (meth)acrylates may be used, such as dipropylene glycol di(meth)acrylate, triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonane diol di(meth)acrylate, neopentyl glycol di(meth)acrylate, tricyclodecanedimethanol diacrylate, bisphenol A ethylene oxide adduct di(meth)acrylate, bisphenol A propylene oxide adduct di(meth)acrylate, hydroxypivalic acid neopentyl glycol di(meth)acrylate, and polytetramethylene glycol di(meth)acrylate.

The (meth)acrylate may be a trifunctional or more polyfunctional (meth)acrylate, such as trimethylolpropane tri(meth)acrylate, ethylene oxide-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerinpropoxy tri(meth)acrylate, caprolactone-modified trimethylolpropane tri(meth)acrylate, pentaerythritolethoxy tetra(meth)acrylate, or caprolactam-modified dipentaerythritol hexa(meth)acrylate.

Among these (meth)acrylates, preferably, the polymerizable compound contains a monofunctional (meth)acrylate. Since monofunctional monomers have high stretchability when being cured into coatings and have a low viscosity, they can help stable ejection of the ink composition. In addition, from the viewpoint of increasing the hardness of the coating, a monofunctional (meth)acrylate and a bifunctional (meth)acrylate may be combined.

More specifically, the polymerizable compound is preferably at least one selected from among dipropylene glycol di(meth)acrylate, tricyclodecanedimethanol diacrylate, phenoxyethyl acrylate (hereinafter may be referred to as PEA), 4-hydroxybutyl acrylate (hereinafter may be referred to as 4HBA), 2-(2-vinyloxyethoxy)ethyl acrylate (hereinafter may be referred to as VEEA), and tetrahydrofurfuryl acrylate (hereinafter may be referred to as THFA). Among these, dipropylene glycol di(meth)acrylate, tricyclodecanedimethanol diacrylate and phenoxyethyl acrylate are more preferred. The use of these polymerizable compounds can enhance the solubility of the ink composition.

Preferably, the monofunctional (meth)acrylate has at least one skeleton selected from among aromatic ring skeletons, saturated alicyclic skeletons, and unsaturated alicyclic skeletons. When the polymerizable compound is a monofunctional (meth)acrylate having such a skeleton, the viscosity of the resulting ink composition can be reduced, and the epoxy-containing polymer can be dissolved in the ink composition effectively.

Monofunctional (meth)acrylates having an aromatic ring skeleton include phenoxyethyl(meth)acrylate and 2-hydroxy-3-phenoxypropyl(meth)acrylate. Monofunctional (meth)acrylates having a saturated alicyclic skeleton include isobornyl(meth)acrylate, t-butylcyclohexyl (meth)acrylate and dicyclopentanyl(meth)acrylate. Monofunctional (meth)acrylates having an unsaturated alicyclic skeleton include dicyclopentenyloxyethyl (meth)acrylate.

The above polymerizable compounds may be used singly or in combination. From the viewpoint of ensuring the rub fastness of the ink composition after being cured, the polymerizable compound content in the ink composition is preferably 20% by mass or more, and more preferably 60% to 90% by mass.

### Photopolymerization Initiator

The photopolymerization initiator in the ink composition of the present embodiment produces an active species, such as a radical or a cation, with light energy, such as UV light, and thus initiates a polymerization of the polymerizable compound. For example, a photo-radical polymerization initiator or a photo-cationic polymerization initiator may be used without other limitations, and preferably, a photo-radical polymerization initiator is used.

Examples of the photo-radial polymerization initiator include aromatic ketones, acylphosphine compounds, aromatic onium salt compounds, organic peroxides, thio compounds, hexaaryl biimidazole compounds, ketoxime ester compounds, borate compounds, azinium compounds, metallocene compounds, active ester compounds, compounds having a carbon-halogen bond, and alkylamine compounds.

More specifically, examples of such a photo-radical polymerization initiator include acetophenone, acetophenone benzyl ketal, 1-hydroxycyclohexylphenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyldimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, bis(2,4,6-trimethylbenzoyl)-phenylphosphine oxide, 2,4,6-trimethylbenzoyldiphenylphosphine oxide, 2,4-diethylthioxanthone, and bis(2,6-dimethoxybenzoyl)-2,4,4-trimethylpentylphosphine oxide.

Commercially available photo-radical polymerization initiators include IRGACURE 651 (2,2-dimethoxy-1,2-diphenylethane-1-one), IRGACURE 184 (1-hydroxycyclohexylphenyl ketone), DAROCUR 1173 (2-hydroxy-2-methyl-1-phenyl-propane-1-one), IRGACURE 2959 (1-[4-(2-hydroxyethoxy)phenyl]-2-hydroxy-2-methyl-1-propane-1-one), IRGACURE 127 (2-hydroxy-1-{4-[4-(2-hydroxy-2-methyl-propionyl)-benzyl]phenyl}-2-methyl-propane-1-one), IRGACURE 907 (2-methyl-1-(4-methylthiophenyl)-2-morpholinopropane-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)-phenylphosphine oxide), IRGACURE 784 (bis(η5-2,4-cyclopentadiene-1-yl)-bis(2,6-difluoro-3-(1H-pyrrole-1-yl)-phenyl) titanium), IRGACURE OXE 01 (1,2-octanedione,1-[4-(phenylthio)phenyl]-,2-(O-benzoyloxime), IRGACURE OXE 02 (ethanone,1-[9-ethyl-6-(2-methylbenzoyl)-9H-carbazole-3-yl]-,1-(O-acetyloxime)), and IRGACURE 754 (mixture of oxyphenyl acetic acid 2-[2-oxo-2-phenylacetoxyethoxy]ethyl ester and oxyphenyl acetic acid 2-(2-hydroxyethoxy)ethyl ester) (each produced by BASF); DETX-S (2,4-diethylthioxanthone) (produced by Nippon Kayaku); Lucirin TPO, LR8893 and LR8970 (each produced by BASF); and Ubecryl P36 (produced by UCB).

The photopolymerization initiator contains an acylphosphine-based photopolymerization initiator having a phenyl group in its molecule so as to be able to produce an effect, called photo-bleaching, advantageous to the hue of the cured film of the ink composition.

Examples of the acylphosphine-based photopolymerization initiator having a phenyl group include, but are not limited to, bis(2,4,6-trimethylbenzoyl)phenylphosphine oxide (IRGACURE 819), 2,4,6-trimethylbenzoyl-diphenylphosphine oxide (DAROCUR TPO), and IRGACURE 1870. Among these, IRGACURE 819 and DAROCUR TPO are preferred from the viewpoint of the photoresponse to the wavelength of the light source, and IRGACURE 819 is more preferred.

Other photopolymerization initiators different from acylphosphine-based photopolymerization initiators may be added, such as α-hydroxyalkylphenone-based photopolymerization initiators.

The photopolymerization initiator content in the ink composition is preferably 3.0% by mass or more, and more preferably in the range of 7% to 12% by mass. When the photopolymerization initiator content is in such a range, the ink composition can exhibit both high curability and high storage stability.

When DAROCUR TPO is used as a photopolymerization initiator, its content in the ink composition is preferably 3.0% by mass or more and less than 5.0% by mass. In this instance, not only the degradation of the sensitivity can be suppressed, but also the environmental safety can be enhanced.

The above photopolymerization initiators may be used singly or in combination.

### Fluorescent Brightening Agent

The fluorescent brightening agent in the ink composition of the present embodiment is a type of sensitizer. The fluorescent brightening agent is a colorless or tinted compound that can absorb light having wavelengths in the range of about 300 to 450 nm, from ultraviolet light to short wavelength visible light, and can emit fluorescence having a wavelength in the range of about 400 to 500 nm. Fluorescent brightening agents are known as fluorescent whitening agents. The physical principle and chemical properties of fluorescent brightening agents are described in Ullmann's Encyclopedia of Industrial Chemistry, Sixth Edition, Electronic Release, Wiley-VCH, 1998.

The fluorescent brightening agent is excited by active energy rays and interacts (for example, performs energy transfer or electron transfer) with other substances, such as a radical generator or an acid generator, thereby promoting the generation of an useful species, such as a radical or an acid. Such interaction can occur, for example, when the energy level of the fluorescent brightening agent molecule in a triplet excited state is very close to and slightly higher than the energy level of the radical generator or acid generator in a triplet excited state. In practice, it is required that the fluorescent brightening agent can collect light having wavelengths in the range of 350 to 450 nm, and that the energy level of the fluorescent brightening agent in a triplet excited state has a specific relationship with that of the radical generator or acid generator in a triplet excited state. It is therefore required that the energy levels in a singlet excited state and in a triplet excite state are close to each other. Accordingly, the fluorescent brightening agent is selected in view of the interaction with the radical generator or acid generator, and in addition, it is preferable that the absorption wavelength region of the fluorescent brightening agent overlap with the absorption wavelength region of the photopolymerization initiator, in view of the efficiency of radical or acid generation in the ink liquid by irradiation with light having a wavelength.

In this instance, the fluorescent brightening agent used in the present embodiment has an absorption wavelength region that overlaps with the absorption wavelength region in which the photopolymerization initiator can be cloven.

In the present embodiment, by using a fluorescent brightening agent as a sensitizer, the hue of the ink composition can be improved, that is, the b* value can be significantly reduced.

Examples of the fluorescent brightening agent include, but are not limited to, naphthalene benzoxazoyl derivatives, thiophene benzoxazoyl derivatives, stilbene benzoxazoyl derivatives, coumarin derivatives, styrene biphenyl derivatives, pyrazolone derivatives, stilbene derivatives, styryl derivatives of benzene and biphenyl, bis(benzazol-2-yl) derivatives, carbostyryl, naphthalimide, dibenzothiophene-5,5′-dioxide derivatives, pyrene derivatives, and pyridotriazole. These may be used singly or in combination.

In order to further improve the hue of the ink composition (to reduce the b* value), a thiophene benzoxazoyl derivative is preferably used as the fluorescent brightening agent. A thiophene benzoxazoyl derivative can be available as, for example, TINOPAL OB from BASF.

The fluorescent brightening agent used in the present embodiment has a higher maximum absorbance in the wavelength region of 360 to 420 nm than the photopolymerization initiator in the same wavelength region, when they are in the same predetermined concentration. The present inventors found that ink compositions having this feature can exhibit extremely high curability.

In order to prepare a photopolymerization initiator and a fluorescent brightening agent that have the feature above, the photopolymerization initiator and the fluorescent brightening agent that are to be used are analyzed for their respective absorption spectra and the maximum absorbances and peak wavelengths in the spectra. Then, it is determined from the measured maximum absorbances whether the photopolymerization initiator and the fluorescent brightening agent have the above feature. When the photopolymerization initiator and the fluorescent brightening agent have the above feature, they can be used in the ink composition of the present embodiment. Preferred combinations of the photopolymerization initiator and the fluorescent brightening agent will be described later in Examples I, II and III.

If an UV light emitting diode (LED) is used as the light source for measuring the absorption spectra of the photopolymerization initiator and the fluorescent brightening agent, the LED has an emission peak wavelength, for example, in the range of 360 to 420 nm. The number of LEDs is not limited to one, and a plurality of LEDs may be used so as to emit light having a plurality of emission peak wavelengths. For example, some LEDs are combined to emit light having peak wavelengths of 365, 385, 395 and 405 nm.

The fluorescent brightening agent may contain a single constituent, or may be a mixture of two or more types. The fluorescent brightening agent content in the ink composition is preferably in the range of 0.10% to 0.75% by mass, and more preferably in the range of 0.25% to 0.50% by mass. By controlling the fluorescent brightening agent content in these ranges, the effect of fluorescent brightening agent on the hue of the cured film can be reduced.

The ink composition of the present embodiment may contain another sensitizer in combination with the fluorescent brightening agent. For example, a thioxanthone-based sensitizer may be used as such a sensitizer. A commercially available thioxanthone-based sensitizer can be used, such as Speed Cure DETX or Speed Cure ITX (each produced by LAMBSON).

### Color Material

The ink composition of the present embodiment may contain a color material, except for clear ink compositions. The color material is selected from among pigments and dyes.

### Pigment

A pigment used as a color material in the present embodiment can enhance the light fastness of the ink composition. The pigment may be selected from inorganic pigments or organic pigments.

Inorganic pigments that can be used in the present embodiment include carbon blacks, such as furnace black, lampblack, acetylene black, channel black and titanium black (for example, C. I. Pigment Black 7 and Degussa SPECIAL BLACK 250). Iron oxide and titanium oxide may be used.

Exemplary organic pigments include insoluble azo pigments, such as insoluble azo pigments, condensed azo pigments, azo lake, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates, such as basic dye chelates and acid dye chelates; dye lakes, such as basic dye lakes and acid dye lakes; and nitro pigments, nitroso pigments, aniline black, and daylight fluorescent pigments.

The above pigments may be used singly or in combination. The pigment content in the ink composition is preferably in the range of 2% to 25% by mass.

### Dye

A dye may be used as a color material. Any dye, such as acid dyes, direct dyes, reactive dyes, and basic dyes, may be used without particular limitation. Exemplary dyes include C. I. Acid Yellows 17, 23, 42, 44, 79 and 142, C. I. Acid Reds 52, 80, 82, 249, 254 and 289, C. I. Acid Blues 9, 45 and 249, C. I. Acid Blacks 1, 2, 24 and 94, C. I. Food Blacks 1 and 2, C. I. Direct Yellows 1, 12, 24, 33, 50, 55, 58, 86, 132, 142, 144 and 173, C. I. Direct Reds 1, 4, 9, 80, 81, 225 and 227, C. I. Direct Blues 1, 2, 15, 71, 86, 87, 98, 165, 199 and 202, C. I. Direct Blacks 19, 38, 51, 71, 154, 168, 171 and 195, and C. I. Reactive Reds 14, 32, 55, 79 and 249, and C. I. Reactive Blacks 3, 4 and 35.

### Dispersant

A dispersant may be added to the ink composition so as to enhance the dispersibility of the pigment. The dispersant is not particularly limited. For example, a dispersant that is generally used for preparing a pigment-dispersed liquid, such as a polymer dispersant, can be used. Examples of such a dispersant include polyoxyalkylene polyalkylene polyamines, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins. The dispersant may contain these compound singly or in combination. Commercially available polymer dispersants include BYK series produced by BYK, AJISPER series produced by Ajinomoto Fine-Techno, and SOLSPERSE series produced by Noveon, and Disparlon series produced by Kusumoto Chemicals.

### Surfactant

The UV-curable ink jet ink composition may further contain a surfactant, such as silicone surfactants, without particular limitation. Preferred silicone surfactants include polyester-modified silicones and polyether-modified silicones. More specifically, polyether-modified polydimethyl siloxane and polyester-modified polydimethyl siloxane are preferred. For example, BYK-347, BYK-348, BYK-377, BYK-378, and BYK-UV3500, -UV3510, -UV3530 and -UV3570 (each produced by BYK) may be used.

### Other Additives

The ink composition of the present embodiment may additionally contain a polymerization inhibitor. Examples of the polymerization inhibitor include, but are not limited to, IRGASTAB UV10 and UV22 (produced by BASF), and hydroquinone monomethyl ether (produced by Kanto Chemical). The polymerization inhibitor enhances the storage stability of the ink composition.

In addition, the ink composition may contain other additives without particular limitation. For example, known additives may be contained if necessary, such as wetting agents (moisturizing agents), penetrants (penetration accelerators), organic solvents, antifungal agents or preservatives, rust preventives, antioxidants, thickeners, saccharides, pH adjusters, (fixative) resins, polyalkylene glycols, and surface tension adjusting agents.

The above-described UV-curable ink composition of the present embodiment is superior in curability and light fastness, and is, in addition, hardly stained at the beginning of being cured because of the effect of the fluorescent brightening agent. Also, the ink composition exhibits high light fastness.

### Recording Medium

The ink composition of the present embodiment is used in an ink jet recording method to from an image on a recording medium.

The recording medium may be absorbable or nonabsorbable. If a nonabsorbable recording medium is used, the medium may be required to be dried after curing the ink composition by UV irradiation.

Examples of the absorbable recording medium include, but are not limited to, plane paper such as electrophotographic paper and ink jet paper, and art paper, coated paper and cast-coated paper that are used in ordinary offset printing. The ink jet paper is, more specifically, a special paper used for ink jet printing and having an ink absorbing layer containing silica particles or alumina particles or an ink absorbing layer made of a hydrophilic polymer such as polyvinyl alcohol (PVA) or polyvinyl pyrrolidone (PVP).

Nonabsorbable recording media include, but are not limited to, plastic films or plates, such as those of polyvinyl chloride, polyethylene, polypropylene, and polyethylene terephthalate (PET); metal plates, such as those of iron, silver, copper, and aluminum; metal-coated metal plates or plastic films formed by vapor-depositing those metals on a metal plate or plastic film; and alloy plates, such as those of stainless steel and brass.

### Ink Jet Recording Method

The ink composition of the present embodiment is preferably used for ink jet recording. An exemplary ink jet recording method will be described below. In an ink jet recording method in which the ink composition of the present embodiment is used, the ink composition is ejected onto a recording medium, and the ink composition deposited on the recording medium is cured by being irradiated with light. The ink composition is thus cured to form a coating on the recording medium.

### Ejection of Ink Composition

For ejecting the ink composition, a known ink jet recording apparatus may be used. The ejection of the ink composition is preferably performed by heating to a predetermined temperature the ink composition whose viscosity has been reduced to a predetermined value. The viscosity is reduced preferably to 30 mPa·s or less, and more preferably to 20 mPa·s or less. The ink composition is ejected in such a condition.

The UV-curable ink composition of the present embodiment has a higher viscosity than aqueous ink compositions generally used for ink jet recording. Accordingly, the viscosity of the UV-curable ink composition is significantly varied by the changes in temperature during ejection. The variation of the viscosity of the ink composition affects the size of the ink droplets and the ejection speed of the droplets and may result in a degraded image quality. It is therefore preferable that the temperature during ejecting the ink composition be kept constant as much as possible.

### Curing of Ink Composition

The ink composition deposited on the recording medium is cured by being irradiated with light. This is because the photopolymerization initiator in the ink composition is decomposed to produce an initiation species, such as a radical, an acid or a base, by the irradiation, and the initiation species induces the polymerization of the polymerizable compound.

The light may be UV light. A mercury lamp or a solid laser is generally used as a light source. For curing UV-curable ink jet ink compositions, a mercury lamp or a metal halide lamp is widely used. However, since it is desired to be mercury-free from the viewpoint of environmental protection, the use of GaN-based semiconductor UV emission devices is advantageous in industry and environment. Also, LEDs (UV-LEDs) and laser diodes (UV-LDs) are small and inexpensive and have long life and high efficiency, and are considered to a useful light source for photo-curable ink jet recording. Among those, UV-LEDs are preferably used.

The light source has a wavelength or a plurality of wavelengths without particular limitation.

### EXAMPLES

The embodiment of the invention will now be further described in detail with reference to Examples, but the invention is not limited to those Examples.

A black ink (Br), a white ink (W) and a clear ink (CL) were prepared as ink compositions, and were combined into an ink set. The preparations of the ink compositions and the ink set will be described in detail below.

### Example I

### Preparation of Pigment Dispersion

Before preparing the ink compositions, pigment dispersions were prepared. Constituents shown in Table 1 were combined and stirred for one hour. The resulting mixture was blended in a bead mill to disperse the pigment, thus yielding a pigment dispersion. The dispersion was performed using zirconia beads of 0.65 mm in diameter with a filling rate of 70% for 2 to 4 hours at a peripheral speed of 9 m/s.

TABLE 1

| | Carbon | Titanium | Disper- | Disper- | Polymerizable |
|---|---|---|---|---|---|
| | black | dioxide | sant A | sant B | compound |
| | (wt %) | (wt %) | (wt %) | (wt %) | (wt %) |
| Black pigment | 40 | — | 25 | — | 35 |
| dispersion A | | | | | |
| White pigment | — | 60 | — | 5 | 35 |
| dispersion B | | | | | |

The pigment, the dispersants and the polymerizable compound used in Example I, shown in Table 1, are as follows:

Carbon black: SPECIAL BLACK 250 (produced by Degussa)

Titanium oxide: CR60-2 (produced by Ishihara Sangyo)

Dispersant A: BYK-168 (produced by BYK)

Dispersant B: SOLSPERSE 36000 (produced by Noveon)

Polymerizable compound A: phenoxyethyl acrylate (PEA) (Biscoat D192, produced by Osaka Organic Chemical Industry)

### Preparation of Ink Compositions

Constituents according to the compositions shown in Tables 2 and 3 (unit: % by mass or mass %) were combined and stirred to yield ink compositions. Tables 2 and 3 show that: the ink compositions (Bk, W and CL) shown in Table 2 were combined to prepare ink sets A to H; and that each ink composition contained a sensitizer in a content shown in Table 3, 99% by mass of other constituents, and the balance of additional phenoxyethyl acrylate.

TABLE 2

| | | | Bk | W | CL |
|---|---|---|---|---|---|
| Polymerizable | | 4-Hydroxybutyl | 10.4 | 12.9 | 12.9 |
| compound | | acrylate | | | |
| | | Dipropylene glycol | 19 | 19 | 19 |
| | | diacrylate | | | |
| | | Phenoxyethyl | 51.8 | 46.8 | 59.8 |
| | | acrylate | | | |
| Acylphosphine- | | IRGACURE 819 | 5.0 | 2.5 | 2.5 |
| based | | DAROCUR TPO | 4.5 | 4.5 | 4.5 |
| photopolymerization | | | | | |
| initiator | | | | | |
| Pigment | Bk | Compound shown | 8 | — | — |
| dispersion | | in Table 1 | | | |
| | W | Compound shown | — | 13.0 | — |
| | | in Table 1 | | | |
| Sensitizer | | None | (see | (see | (see |
| | | | Table 3) | Table 3) | Table 3) |
| | Xanthone- | DETX | (see | (see | (see |
| | based | | Table 3) | Table 3) | Table 3) |
| | | ITX | (see | (see | (see |
| | | | Table 3) | Table 3) | Table 3) |

| | | | |
|---|---|---|---|
| Fluorescent brightening agent | (see | (see | (see |
| (TINOPAL-OB) | Table 3) | Table 3) | Table 3) |

| | | | | |
|---|---|---|---|---|
| Surfactant | BYK-3500 | 0.2 | 0.2 | 0.2 |
| Polymerization | Hydroquinone | 0.1 | 0.1 | 0.1 |
| inhibitor | monomethyl ether | | | |

The constituents shown in Table 2 are as follows:

Phenoxyethyl acrylate: Biscoat D192 (produced by Osaka Organic Chemical Industry)

Dipropylene glycol diacrylate: APG-100 (produced by Shin-Nakamura Chemical)

4-Hydroxybutyl acrylate: 4-HBA (produced by Osaka Organic Chemical Industry)

Acylphosphine-based photopolymerization initiator: IRGACURE 819 (produced by BASF)

Acylphosphine-based photopolymerization initiator: DAROCUR TPO (produced by BASF)

Thioxanthone-based sensitizer: Speed Cure DETX (produced by LAMBSON)

Thioxanthone-based sensitizer: Speed Cure ITX (produced by LAMBSON)

Fluorescent brightening agent: TINOPAL-OB (produced by BASF)

Surfactant: BYK-3500 (produced by BYK)

Polymerization inhibitor: hydroquinone monomethyl ether (produced by Kanto Chemical)

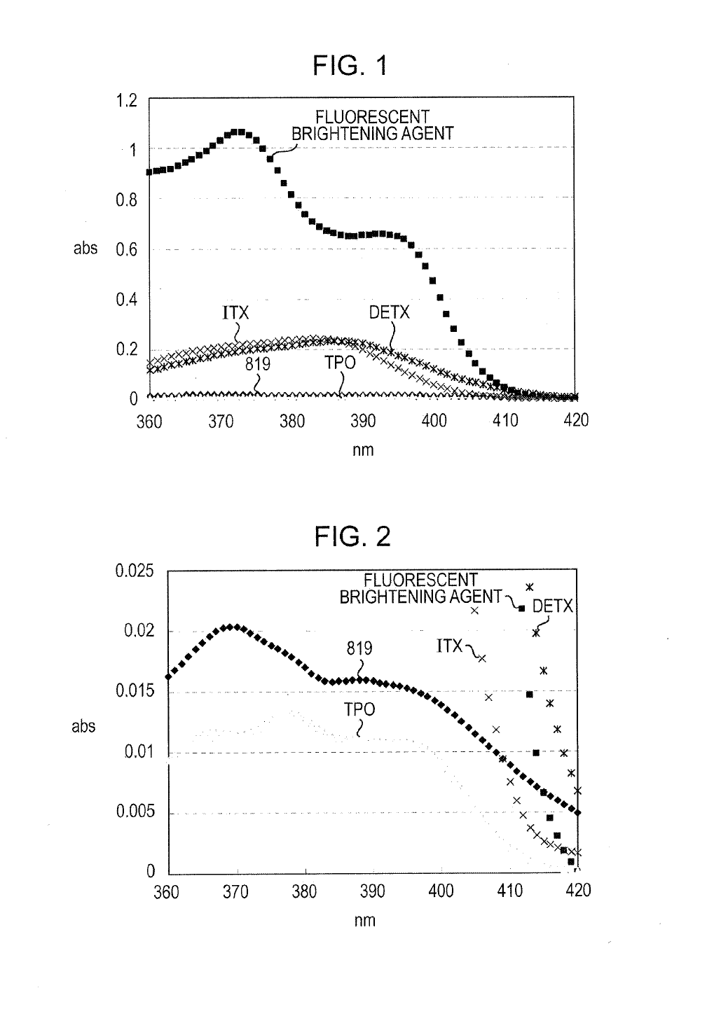

FIG. 1 is a plot showing the absorption spectra of the photopolymerization initiators and the sensitizers including the fluorescent brightening agent, used in Examples I, II and III. FIG. 2 is an enlarged fragment of FIG. 1. To obtain the absorption spectra exhibiting maximum absorbances shown in FIGS. 1 and 2, each sample was diluted to a concentration (solute (g)/(solvent (g)+solute (g))) of 1.0×10⁻⁵% by mass. In this instance, the solute was a fluorescent brightening agent or a sensitizer, or a polymerization initiator, and the solvent was acetonitrile.

As shown in FIGS. 1 and 2, the fluorescent brightening agent TINOPAL-OB used in Examples I, II, and III has a higher maximum absorbance than the photopolymerization initiators, IRGACURE 819 and DAROCUR TPO, in a wavelength region of 360 to 420 nm, when they are in the same concentration.

The five compounds shown in FIGS. 1 and 2 exhibited the following maximum absorbances in the wavelength region of 360 to 420 nm. IRGACURE 819 exhibited a maximum absorbance of 0.02, DAROCUR TPO, 0.013; the fluorescent brightening agent, 1.06; ITX, 0.24; and DETX, 0.23.

### Preparation of Ink Sets

The black ink composition (Bk), the white ink composition (W) and the clear ink composition (CL) were combined to prepare ink sets.

The sensitizer and its content in each of the ink compositions Bk, W and CL constituting ink sets A to H were shown in Table 3 below.

TABLE 3

| Ink set | Sensitizer | Content |
|---|---|---|
| Ink Set A | None | — |
| Ink Set B | DETX | 0.35 mass % |
| Ink Set C | ITX | 0.35 mass % |
| Ink Set D | TINOPAL-OB | 0.05 mass % |
| Ink Set E | TINOPAL-OB | 0.1 mass % |
| Ink Set F | TINOPAL-OB | 0.35 mass % |
| Ink Set G | TINOPAL-OB | 0.75 mass % |
| Ink Set H | TINOPAL-OB | 1.0 mass % |

### Preparation of Recorded Material

A solid pattern was printed on a PET film with the UV-curable ink compositions prepared above at a resolution of 720×720 dpi, at a droplet weight of 10 ng, using an ink jet printer PX-5000 (manufactured by Seiko Epson). The solid pattern was irradiated with UV light from a UV emitter (UV-LED, emission peak wavelength: 395 nm, illuminance: 60 mw/cm²) disposed at a side of the carriage. Thus the solid pattern was cured to yield a recorded material. The UV irradiation was continued until the stickiness of the solid pattern disappeared.

### Evaluations and Criteria

### Curability

The dose of irradiation with UV light at which the ink composition could be cured was determined by measuring the total light quantity with an integrating actinometer UM-40 (manufactured by Konica Minolta) when the solid pattern was irradiated until the stickiness of the solid image disappeared. The evaluation results are shown in Table 4. The ink types A, B, C, D, E, F, G and H shown in Table 4 correspond to ink sets A, B, C, D, E, F, G and H, respectively.

The evaluation criteria were as follows. Only the samples determined to be good can be used in practice.

Good: Total light quantity <400 mJ/cm²
Fair: 400 mJ/cm² Total light quantity <800 mJ/cm²
Bad: Total light quantity 800 mJ/cm²

### Stain When Being Cured

For evaluating the stain or hue when the ink composition was cured, only the clear ink composition CL was subjected to measurement. The measurement was performed by measuring the b* values of the recorded materials with a colorimeter (Spectrolino, manufactured by Gretag Macbeth) immediately after the ink composition had been cured. The evaluation results are shown in Table 4.

The evaluation criteria were as follows. Only the samples determined to be good can be used in practice.

Good: b* value <5.0
Bad: b* value 5.0

### Solubility

For evaluating the solubility, only the clear ink composition CL was subjected to a test. After being prepared, the ink composition was allowed to stand at room temperature for 3 days, and then it was visually observed whether a residue was present or not. The evaluation results are shown in Table 4.

The evaluation criteria were as follows. Only the samples determined to be good can be used in practice.

Good: No residue was observed.
Bad: A residue was observed.

### Light Fastness

The recorded material prepared above was allowed to stand in a xenon weather meter XL75 (manufactured by Suga Test Instruments) at a temperature of 63° C. and a illuminance of 70,000 lux, for 300 hours. Thus a test for evaluating the light fastness was performed. The a* value and the b* value of the solid pattern image were measured with a colorimeter (Spectrolino, manufactured by Gretag Macbeth) before and after the above light fastness test. The degree of discoloration after the light fastness test was evaluated from the ΔE value (color difference) calculated from the following equation using the a* and b* values.

ΔE=[L₁-L₂)²+(a₁-a₂)²+(b₁-b₂)²]^{1/2}

(L₁, a₁ and b₁ represent the L*, a* and b* values before the light fastness test, respectively. L₂, a₂ and b₂ represent the L*, a* and b* values after the light fastness test, respectively.)

The evaluation criteria were as follows. The samples determined to be good can be used in practice.

### Good: ΔE<3.0

### Bad: ΔE 3.0

The evaluation results are shown in Table 4.

TABLE 4

| Sample | Ink | Ink | Cur- | Stain when | Solu- | Light |
|---|---|---|---|---|---|---|
| No. | color | type | ability | being cured | bility | fastness |
| Sample 1-1 | Bk | A | Bad | — | — | — |
| Sample 2-1 | | B | Fair | — | — | — |
| Sample 3-1 | | C | Fair | — | — | — |
| Sample 4-1 | | D | Bad | — | — | — |
| Sample 5-1 | | E | Good | — | — | — |
| Sample 6-1 | | F | Good | — | — | — |
| Sample 7-1 | | G | Good | — | — | — |
| Sample 8-1 | | H | Good | — | — | — |
| Sample 1-2 | W | A | Bad | — | — | Bad |
| Sample 2-2 | | B | Fair | — | — | Bad |
| Sample 3-2 | | C | Fair | — | — | Bad |
| Sample 4-2 | | D | Bad | — | — | Good |
| Sample 5-2 | | E | Good | — | — | Good |
| Sample 6-2 | | F | Good | — | — | Good |
| Sample 7-2 | | G | Good | — | — | Good |
| Sample 8-2 | | H | Good | — | — | Good |
| Sample 1-3 | CL | A | Bad | Good | Good | Bad |
| Sample 2-3 | | B | Bad | Bad | Good | Bad |
| Sample 3-3 | | C | Bad | Bad | Good | Bad |
| Sample 4-3 | | D | Bad | Good | Good | Good |
| Sample 5-3 | | E | Good | Good | Good | Good |
| Sample 6-3 | | F | Good | Good | Good | Good |
| Sample 7-3 | | G | Good | Good | Good | Good |
| Sample 8-3 | | H | Good | Good | Bad | Good |

As is clear from the results of the evaluations for curability, solubility, stain when the ink composition was cured, and light fastness, shown in Table 4, ink sets E, F and G are much superior in curability, solubility, hue (decrease in b* value), and light fastness.

### Example II

### Preparation of Ink Compositions

Constituents shown below (unit: % by mass or mass %) were combined and stirred to prepare polymerizable compound composition X.

### Composition X

Phenoxyethyl acrylate: 30% by mass

4-Hydroxybutyl acrylate: balance (about 50% by mass)

Tricyclodecanedimethanol diacrylate: 20% by mass (KAYARAD R-684, produced by'Nippon Kayaku)

The phenoxyethyl acrylate and the 4-hydroxy butyl acrylate were the same as those used in Example I. The reason why the 4-hydroxybutyl acrylate content in composition X is the “balance” is that since the total amount of photopolymerization initiator in each ink composition was different, the 4-hydroxybutyl acrylate content was adjusted so as to prepare 100% by mass of ink composition as shown in Table 5.

Composition X and the constituents shown Table 5 (unit: % by mass or mass %) were combined and stirred to prepare clear ink compositions (samples 9 to 23).

### Preparation of Recorded Material

Samples of the recorded material were prepared in the same manner as in Example I, except that the dose of irradiation with UV light was 400 mJ/cm². The resulting recorded material samples were subjected to evaluations in the same manner as in Example I.

In Example II, clear ink compositions were evaluated. Also, the present inventors evaluated color ink compositions in the same manner as Example II, and found that a yellow tinge was added to the original color to the same extent as the results below.

TABLE 5

| | | | | | | Fluorescent | | Stain when | Light |
|---|---|---|---|---|---|---|---|---|---|
| Sample | 819 | TPO | 369 | DETX | ITX | brightening agent | Curability | being cured | fastness |
| 9 | 4.0 | 4.5 | — | — | — | 0.5 | Good | Good | Good |
| 10 | 3.0 | 4.5 | — | — | — | 0.5 | Good | Good | Good |
| 11 | 2.0 | 4.5 | — | — | — | 0.5 | Good | Good | Good |
| 12 | 1.0 | 4.5 | — | — | — | 0.5 | Good | Good | Good |
| 13 | 0.0 | 4.5 | — | — | — | 0.5 | Bad | Good | Good |
| 14 | 4.0 | 4.8 | — | — | — | — | Fair | Good | Good |
| 15 | 4.0 | 4.8 | — | 0.5 | — | — | Fair | Bad | Bad |
| 16 | 4.0 | 4.8 | — | — | 0.5 | — | Fair | Bad | Bad |
| 17 | 4.0 | 4.8 | — | — | — | 0.5 | Good | Good | Good |
| 18 | 4.0 | 4.8 | 0.5 | — | — | — | Fair | Good | Bad |
| 19 | 4.0 | — | — | — | — | 0.5 | Good | Good | Good |
| 20 | 3.0 | — | — | — | — | 0.5 | Good | Good | Good |
| 21 | 2.0 | — | — | — | — | 0.5 | Bad | Good | Good |
| 22 | 1.0 | — | — | — | — | 0.5 | Bad | Good | Good |
| 23 | 0.0 | — | — | — | — | 0.5 | Bad | Good | Good |

In Table 5, 819 represents IRGACURE 819 (produced by BASF); TPO represents DAROCUR TPO (produced by BASF); 369 represents IRGACURE 369 (produced by BASF); DETX represents Speed Cure DETX (produced by LAMBSON); ITX represents Speed Cure ITX (produced by LAMBSON); and the fluorescent brightening agent is TINOPAL-OB (produced BASF).

### Evaluations and Criteria

The evaluations for curability, stain when the ink composition was cured, and light fastness were performed in the same manner as in Example I, and description thereof is omitted. In the evaluations, even when the coating of the ink composition was not fully cured, that is, even when the curability was determined to be bad or fair, the stain in the coating and the light fastness were evaluated because the coating was cured to some extent.

Table 5 shows that Samples 9, 10, 11, 12, 17, 19 and 20, each of which contains a predetermined amount or more of an acylphosphine-based photopolymerization initiator (IRGACURE 819) and a fluorescent brightening agent as a sensitizer, are superior in curability, hue (decrease in b* value), and light fastness.

### Example III

### Preparation of Ink Compositions

Composition X and the constituents shown Table 6 (unit: % by mass or mass %) were combined and stirred to prepare clear ink compositions (samples 24 and 25). In Example III, clear ink compositions were evaluated. The present inventors also evaluated color ink compositions in the same manner as Example III, and found that a yellow tinge was added to the original color to the same extent as the results below.

Samples of the recorded material were prepared in the same manner as in Example II. The evaluations were performed in the same manner as in Example I.

TABLE 6

| | | | | | | | Stain | |
|---|---|---|---|---|---|---|---|---|
| | | | | HOSTA | | Cur- | when | Light |
| Sam- | | | White | LUX | Solu- | abil- | being | fast- |
| ple | 819 | TPO | flourB | KS | bility | ity | cured | ness |
| 24 | 4.0 | 4.8 | 0.5 | — | Soluble | Fair | Good | Good |
| 25 | 4.0 | 4.8 | — | 0.5 | Insoluble | — | — | — |

In Table 6, white flour B is a coumarin derivative (produced by Sumika Color) as a fluorescent brightening agent, and HOSTALUX KS is a stilbene benzoxazoyl derivative (produced by Clariant International) as a fluorescent brightening agent.

The entire disclosure of Japanese Patent Application No. 2010-170433, filed Jul. 7, 2010 is expressly incorporated by reference herein.

What is claimed is:

1. A UV-curable ink jet ink composition comprising:
a polymerizable compound;
a photopolymerization initiator containing an acylphosphine-based photopolymerization initiator having a phenyl group in the molecule thereof; and
a fluorescent brightening agent,
wherein the fluorescent brightening agent in a predetermined concentration has a higher maximum absorbance than the photopolymerization initiator in the same concentration, in a wavelength region of 360 to 420 nm.

2. The UV-curable ink jet ink composition according to claim 1, wherein the photopolymerization initiator contains bis(2,4,6-trimethylbenzoyl)phenylphosphine oxide.

3. The UV-curable ink jet ink composition according to claim 1, wherein the photopolymerization initiator content in the UV-curable ink jet ink composition is 3.0% by mass or more.

4. The UV-curable ink jet ink composition according to claim 1, wherein the fluorescent brightening agent is a thiophene benzoxazoyl derivative.

5. The UV-curable ink jet ink composition according to claim 1, wherein the fluorescent brightening agent content in the UV-curable ink jet ink composition is in the range of 0.1% to 0.75% by mass.
